(19) United States
(12) Patent Application Publication
(10) Pub. No.: US 2026/0190048 A1
(43) Pub. Date: Jul. 2, 2026

(54) PRE-SYNCHRONIZATION SIGNAL DESIGN

(71) Applicant: QUALCOMM Incorporated, San Diego, CA (US)

(72) Inventors: Kangqi LIU, San Diego, CA (US); Weimin DUAN, San Diego, CA (US); Lianghai JI, San Diego, CA (US)

(21) Appl. No.: 19/005,925

(22) Filed: Dec. 30, 2024

(51) Int. Cl. H04W 56/00; H04J 11/00; H04W 84/06

(52) U.S. Cl. CPC H04W 56/0015; H04J 11/0069; H04W 84/06

(57) ABSTRACT

Certain aspects of the present disclosure provide techniques for signaling what sync rasters via different types of patterns. In some cases, a network entity (e.g., a gNB) may indicate a sync raster by transmitting a pattern formed by a first signal associated with a frequency that increases in time for at least a first duration according to a first slope and a second signal associated with a frequency that decreases in time for at least a second duration according to a second slope. Different patterns may map to different sync rasters. Thus, a user equipment (UE) may scan for synchronization signals according to a sync raster associated with a detected pattern.

### FIELD OF THE DISCLOSURE

Aspects of the present disclosure relate to wireless communications, and more particularly, to techniques for signaling frequency resources for upcoming synchronization signal transmissions.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication. The method includes obtaining a signal associated with a pattern formed by a first signal associated with a frequency that increases in time for at least a first duration according to a first slope and a second signal associated with a frequency that decreases in time for at least a second duration according to a second slope; and scanning for a synchronization signal (SS) based on a synchronization raster associated with the pattern.

Another aspect provides a method for wireless communication. The method includes outputting a signal associated with a pattern formed by a first signal associated with a frequency that increases in time for at least a first duration according to a first slope and a second signal associated with a frequency that decreases in time for at least a second duration according to a second slope; and outputting one or more synchronization signals (SSs) based on a synchronization raster associated with the pattern.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A and 5B depict an example frequency modulated continuous wave (FMCW) waveform.

FIG. 6 depicts example receiver-side processing of an FMCW waveform.

FIGS. 7 and 8 depict examples of FMCW-based channel estimation.

FIG. 9 depicts an example of FMCW-based bandwidth part (BWP) selection.

FIGS. 10A and 10B depict an example ambiguity in processing FMCW-based synchronization signals.

FIG. 11 depicts an example FMCW-based synchronization signal, in accordance with aspects of the present disclosure.

FIG. 12 depicts example synchronization signal rasters.

FIG. 13 depicts example impact of Doppler frequency on a synchronization signal raster.

FIG. 14 depicts a call flow diagram illustrating example FMCW-based synchronization signal processing, in accordance with aspects of the present disclosure.

FIG. 15 depicts example patterns of FMCW-based signals, in accordance with aspects of the present disclosure.

FIG. 16 depicts example patterns of FMCW-based signals, in accordance with aspects of the present disclosure.

FIG. 17 depicts example mappings of FMCW-based signal patterns to different synchronization signal rasters, in accordance with aspects of the present disclosure.

FIG. 18 depicts example patterns of FMCW-based signals used to indicate different synchronization signal rasters, in accordance with aspects of the present disclosure.

FIG. 19 depicts example patterns of FMCW-based signals used to indicate different synchronization signal rasters, in accordance with aspects of the present disclosure.

FIG. 20 depicts example options for using patterns of FMCW-based signals to indicate different synchronization signal rasters, in accordance with aspects of the present disclosure.

FIG. 21 depicts a method for wireless communications.

FIG. 22 depicts a method for wireless communications.

FIG. 23 depicts aspects of an example communications device.

### DETAILED DESCRIPTION

Aspects of the present disclosure provide apparatuses, methods, processing systems, and computer-readable mediums for signaling frequency resources for upcoming synchronization signal transmissions.

In 3GPP, a synchronization signal is formed as a combination of the primary synchronization signal (PSS) and the secondary synchronization signal (SSS). These signals are used to determine the physical cell identity (PCID) of a cell, and are part of the Synchronization Signal and PBCH block (SSB). A user equipment (UE) monitors for SSBs as part of a procedure to access a mobile network.

SSBs are periodically transmitted, according to a synchronization (sync) raster, on the downlink from each NR cell to enable devices to find a cell when entering or moving within a system. The UE uses the sync raster to search for the SSBs (time and frequency) locations during an initial cell search. The sync raster indicates the frequency positions of the synchronization block that can be used by the UE for system acquisition. A sync raster is typically defined for each frequency band. In effect, the sync raster defines a grid that is a finite number of locations a UE has to search.

In some cases, a network may transmit a signal to announce or indicate to a UE the SSB deployment. This type of early indication signal may be a relatively simple signal designed to allow detection with reduced complexity. Such a “light SSB” signal can be used by a network entity (e.g., a gNB) to announce the SSB deployment so as to simplify the UE initial cell search.

When a UE detects the light SSB signal, it may know the cell is deployed and the UE may continue to scan for SSBs according to a corresponding sync raster longer to look for the actual SSB. In other words, the UE may continue to scan for SSBs longer than it might otherwise if it did not detect the light SSB signal.

In some cases, a frequency modulated continuous wave (FMCW) based cell detection signal can be used as the light SSB signal. The signal may be designed such that the UE could scan multiple sync raster points at a time, with relatively low complexity. FMCW spreading may help a UE distinguish a light SSB from data during a scan (e.g., being more robust than energy-based detection). Full search performance of FMCW-based PSS matches PSS using m-sequence with a correlation-based detector.

One potential challenge for SSB scans relates to Doppler frequency in certain network deployment scenarios. For example, the maximum service link Doppler frequency (f_{D}) could be substantial (e.g., ±25 parts per million) in a non-terrestrial network (NTN) scenario. For certain operating bands (e.g., sub 3 GHz bands), the Doppler frequency may be +/−75 kHz, which may present a problem due to the minimum distance between two sync raster points, which is 100 KHz. In other words, the Doppler frequency may lead to a misdetection event (e.g., sync raster not detected) and/or a false alarm event (e.g., sync raster falsely declared) of the sync raster detection in the NTN scenario.

Aspects of the present disclosure propose FMCW based signaling mechanisms that may address such issues. The mechanisms may be used, for example, in NTN scenarios under 3 GHz. As will be described in greater detail below, different patterns may be designed for different sync rasters. Detection of a particular pattern, therefore, may provide a UE with an accurate indication of the corresponding sync raster, which may have benefits (e.g., assisting the UE with initial cell detection).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

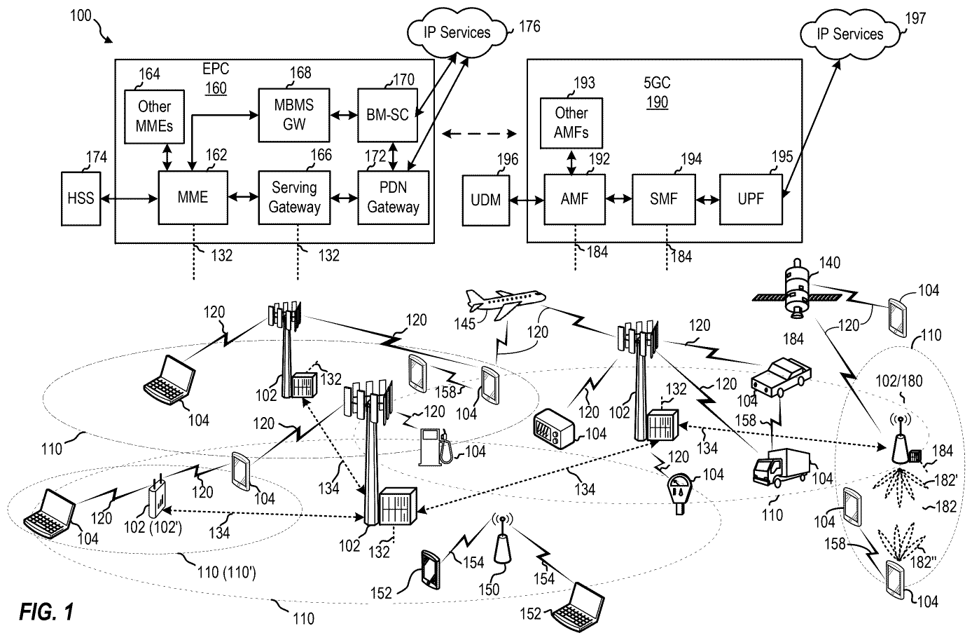

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

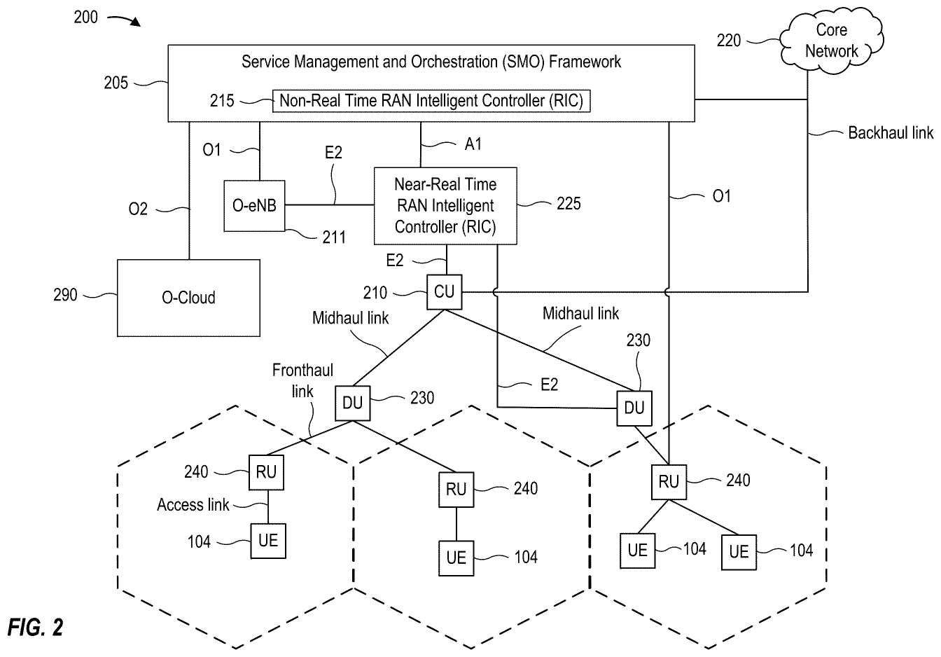

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

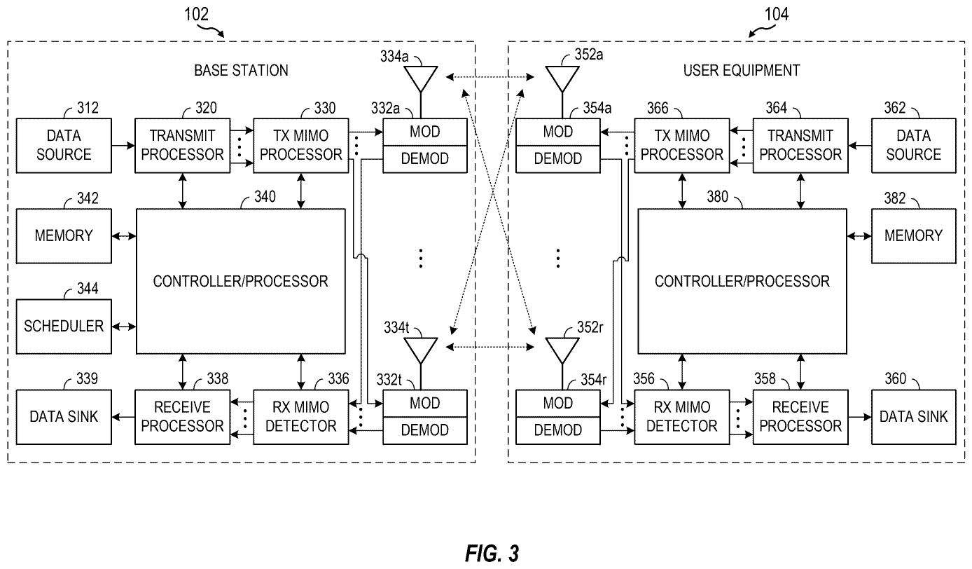

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

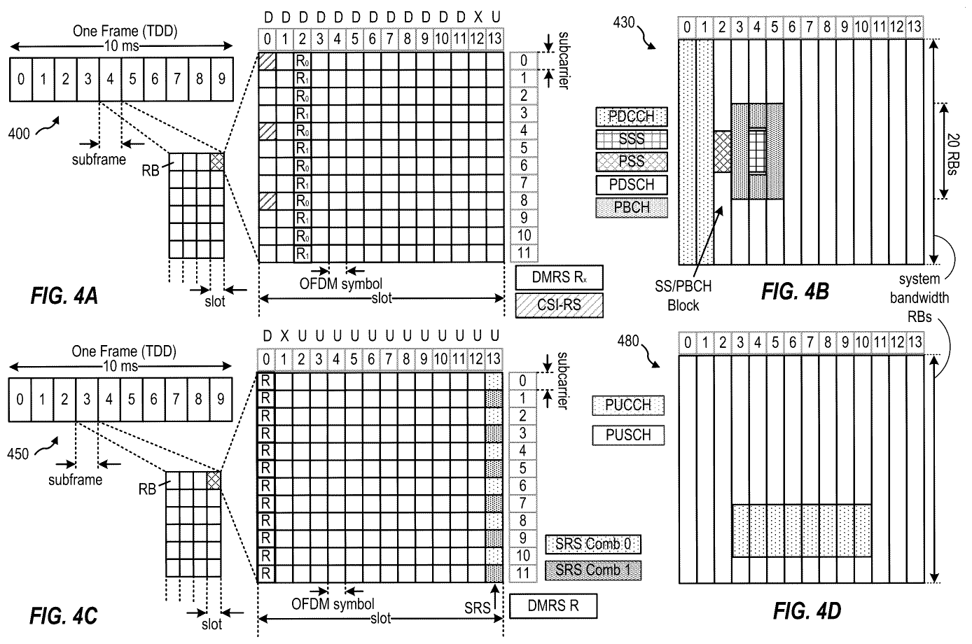

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of FMCW Waveform Processing

As noted above, a frequency modulated continuous wave (FMCW) waveform is a signal where the frequency increases linearly with time (referred to as an up-chirp) or decreases linearly with time (referred to as a down-chirp). In FMCW, a difference between the transmitted signal carrier frequency and the received signal carrier frequency is referred to as a beat frequency.

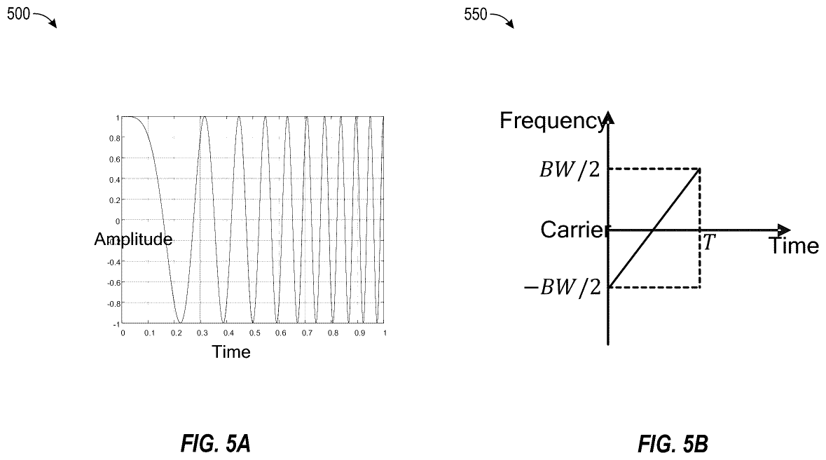

FIG. 5A illustrates an example diagram 500 of an FMCW waveform where the frequency increases linearly with time. As illustrated in diagram 550 of FIG. 5B, the total increase in frequency over a period T is BW (from Carrier-BW/2 to Carrier+BW/2), corresponding to a rate (slope) of BW/T.

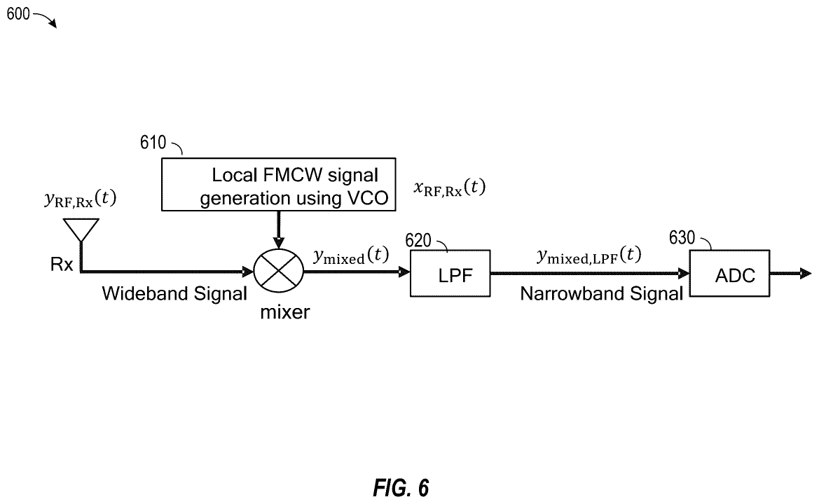

As illustrated in diagram 600 of FIG. 6, at a receiver-side, the received signal is mixed with a local version of the transmitted FMCW (generated via a voltage controlled oscillator-VCO 610) and passed to a low pass filter (LPF 620). The resulting narrowband signal is fed to an ADC 630 and further processing is performed to estimate the beat frequency. In typical FMCW-based radar applications, each beat signal frequency fb maps to a specific target reflection.

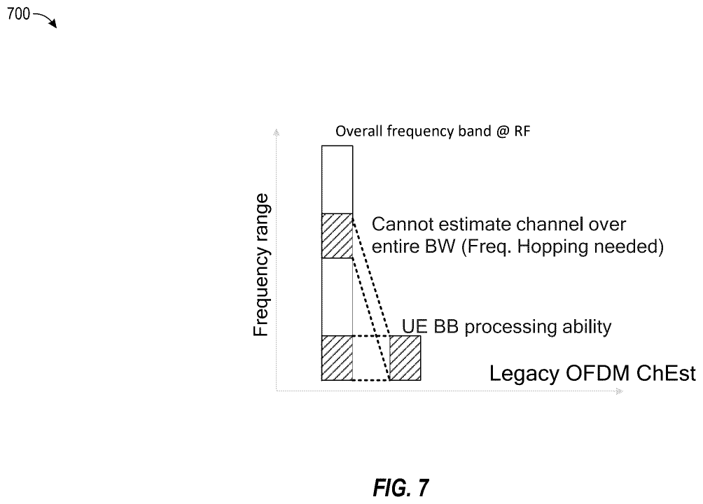

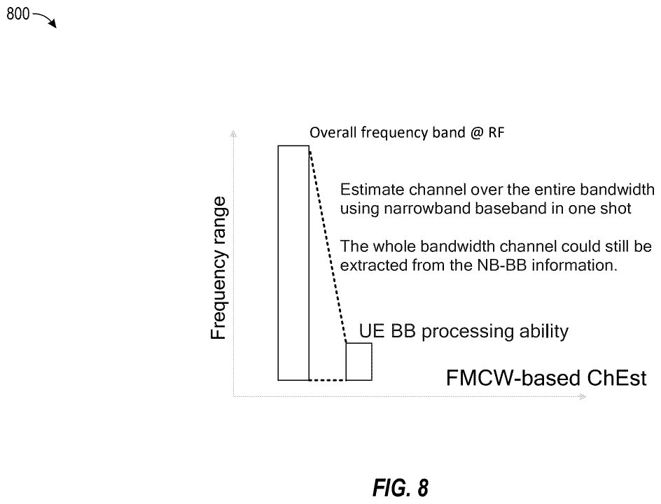

An FMCW signal may enable performing wideband (WB) sensing or channel estimation using narrowband (NB) baseband processing. As illustrated in diagram 700 of FIG. 7, with conventional (e.g., narrow) baseband processing capability, a UE cannot perform channel estimation over an entire bandwidth, without frequency hopping (e.g., which may result in increased latency). As illustrated in diagram 800 of FIG. 8, however, using an FMCW-based synchronization signal, the whole bandwidth channel may be extracted using a UEs relatively narrow baseband processing capability.

With FMCW-base channel estimation, a relatively low-speed ADC may be used to sample the beat signal over a wide range (e.g., from several GHz or 100s MHz, to 10s of MHz, or even less than 10 MHz). FMCW-based synchronization signals may also result in a relatively low peak to average power ratio (PAPR), facilitating low complexity full duplex sensing.

FMCW-based channel estimation may have various use cases, for example, in wide (and ultra-wide) system bandwidth (e.g., 400 MHz˜8 GHz for FR3, 6 GHz, and sub THz). FMCW-based approaches may allow UEs with relative limited capability, such as mid-tier (e.g., Internet of Things/IOT) devices that do not support full system bandwidth (e.g., 20 MHz, 100 MHz, 400 MHz, 1 GHz, etc.) to perform channel estimation over a full system bandwidth using narrowband processing capability.

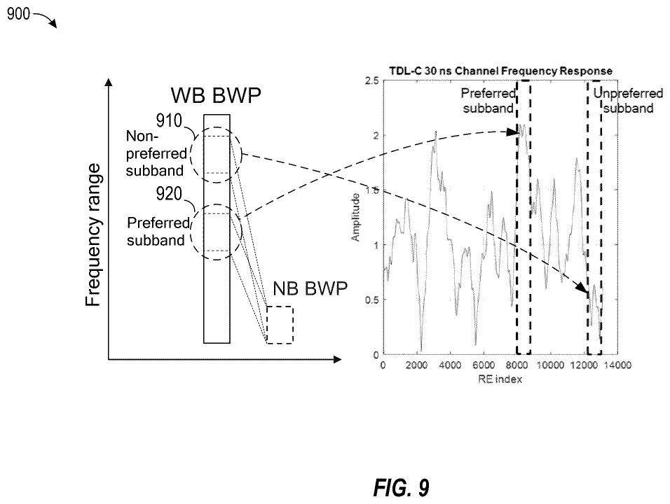

As illustrated in diagram 900 of FIG. 9, FMCW-based processing may allow a UE to scan a larger bandwidth to identify preferred sub-bands. For example, a FMCW-based approach allows a UE to selected particular bandwidth parts (BWPs). In the illustrated example, narrowband baseband processing is able to identify a preferred subband 920 and non-preferred subband 910. From the network perspective, this FMCW-based approach may provide a same resource efficiency for UE-specific NB BWP allocation.

One potential issue with using an FMCW waveform is the potential for timing and frequency offset ambiguity. In other words, in some cases, a frequency offset (e.g., due to oscillator offset) and timing offset may not be distinguishable at the detector output at the receiver.

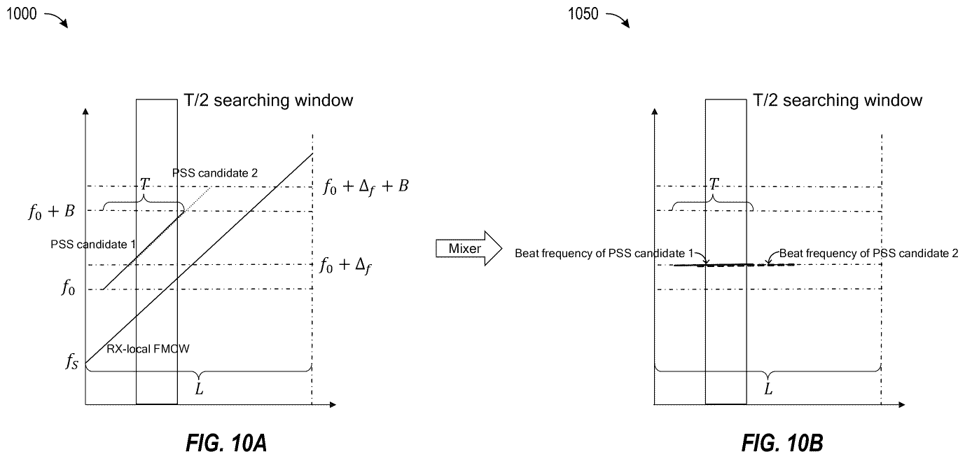

This potential for ambiguity may be understood by considering the example of FMCW waveforms for two PSS candidates, PSS candidate 1 and PSS candidate 2, shown in diagram 1000 of FIG. 10A. As illustrated in diagram 1050 of FIG. 10B, the beat frequency of PSS candidate 1 and of PSS candidate 2 may appear to be the same within a (T/2) searching window.

This ambiguity may make the UE unable to determine the frequency offset and time offset relative to the receiver-local FMCW, which makes the frequency/time synchronization coarse. As a result, precise frequency estimation and timing estimation may need to rely on another type of waveform, such as an SSS using a cyclic prefix orthogonal frequency division multiplexing (CP-OFDM) waveform.

In some cases, an X-shaped FMCW-based synchronization signal may be designed to help resolve/clarify the aforementioned ambiguity.

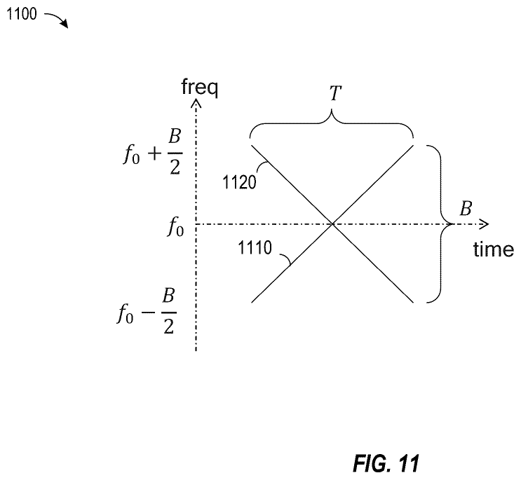

As illustrated in diagram 1100 of FIG. 11, and as will be described in greater detail below, an X-shaped FMCW-based PSS may be formed using a first FMCW waveform 1110 with an associated frequency that increases

$$( ramps up from {f}_{0} - \frac{B}{2} to {f}_{0} + \frac{B}{2} )$$

linearly in time (over a period T) and a second FMCW waveform 1120 with an associated frequency that decreases

$$( ramps down from {f}_{0} + \frac{B}{2} to {f}_{0} - \frac{B}{2} )$$

linearly in time (over T). Thus, the first FMCW waveform 1110 has a slope of B/T, while the second FMCW waveform 1120 has a slope of −B/T.

As illustrated, by using the same up-sweep ramp and down-sweep ramp, the first and second FMCW waveforms 1110 and 1120 form an X shape. A center of the X shape may be defined as fᵢ, a synchronization raster point for a corresponding synchronization signal (e.g., PSS) formed thereby. In some cases, an OFDM architecture may be used to generate the FMCW waveform(s) that for the PSS.

### Aspects Related to a Pre-SSB Design for NTN Under 3 GHz

As noted above, SSBs are periodically transmitted, according to a synchronization (sync) raster, on the downlink from each NR cell to enable devices to find a cell when entering or moving within a system. The UE uses the sync raster defines frequency locations the UE can search for SSBs during an initial cell search. The sync raster indicates the frequency positions of the synchronization block that can be used by the UE for system acquisition.

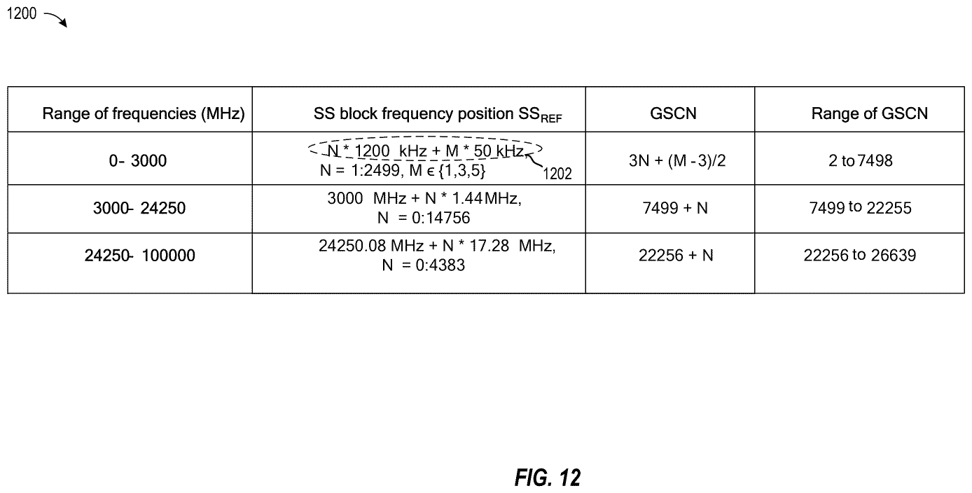

In effect, the sync raster defines a grid that is a finite number of locations a UE has to search. As illustrated in table 1200 of FIG. 12, a sync raster is typically defined for each frequency range. The table illustrates SS block frequency positions (SS_{REF}), for different frequency ranges, as well as equations for determining corresponding Global Synchronization Channel Numbers (GCSNs). GCSNs typically refer to a frequency that identifies the position of the SSB in the frequency domain.

As illustrated, for frequencies between 3 GHz and 24.25 GHz and for frequencies above 24.25 GHz, the sync raster points are uniformly distributed. For frequencies below 3 GHz, the sync raster points are not uniformly distributed, due to a dependence on N (that ranges from 1 to 2499) and a parameter M (that can be a value 1, 3, or 5), as indicated at 1202. As indicated, for this frequency range, values for Global Synchronization Channel Number (GCSN) may range from 2 (with N=1 and M=1) to 7498 (with N=2499 and M=5). GSCN stands for and is a frequency that identifies the position of the synchronous signal block (SSB) in the frequency domain. GSCN is used in 5G NR to help locate the SSB in both frequency and time domains.

As described above, in some cases, a network may transmit a signal to announce or indicate to a UE the SSB deployment. When a UE detects the light SSB signal, it may know the cell is deployed and the UE may continue to scan for SSBs according to a corresponding sync raster longer to look for the actual SSB. In other words, the UE may continue to scan for SSBs longer than it might otherwise if it did not detect the light SSB signal.

In some cases, a frequency modulated continuous wave (FMCW) based cell detection signal can be used as the light SSB signal. The signal may be designed such that the UE could scan multiple sync raster points at a time, with relatively low complexity. FMCW spreading may help a UE distinguish a light SSB from data during a scan (e.g., being more robust than energy-based detection). Full search performance of FMCW-based PSS matches PSS using m-sequence with a correlation-based detector.

One potential challenge for SSB scans relates to Doppler frequency in certain network deployment scenarios. For example, in NTN scenarios, the maximum service link Doppler frequency (f_{D}) could be substantial (±25 ppm). For the NTN S band, the Doppler frequency could be calculated as:

$$2 GHz : {f}_{D} = \pm 50 KHz ;$$

$$2.5 GHz : {f}_{D} = \pm 62.5 KHz ; and$$

$$3 GHz : {f}_{D} = \pm 75 KHz .$$

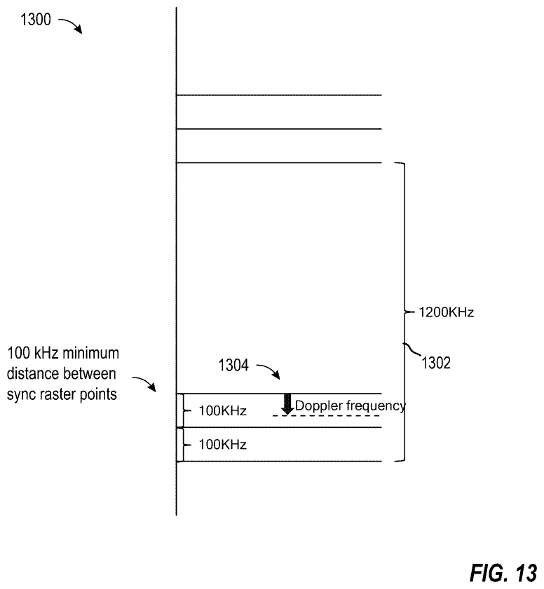

As illustrated in diagram 1300 of FIG. 13, for sub 3 GHz bands, SSBs may be spaced by 1200 kHz (as indicated at 1302), but the minimum distance between sync raster points (for different sync rasters) may be only 100 kHz. Since the Doppler frequency f_{D} may be +/−75 kHz, as indicated at 1304, this may present a problem distinguishing different sync rasters. This Doppler frequency impact may lead to a misdetection event and/or a false alarm event resulting in a UE not detecting the actual sync raster used (e.g., for the same value of N but different values of M (where Nϵ {1,3,5}).

Aspects of the present disclosure propose FMCW based signaling mechanisms that may address such issues. While the mechanisms proposed herein may be used in NTN scenarios under 3 GHz, they may be used in any such scenario subject to similar issues. As will be described in greater detail below, different patterns may be designed for different sync rasters. Detection of a particular pattern, therefore, may provide a UE with an accurate indication of the corresponding sync raster, which may have benefits (e.g., assisting the UE with initial cell detection).

In some cases, the X FMCW based design described above (e.g., for a light SSB/pre-SSB) may be enhanced to address the issues described above for NTN scenarios under 3 GHz. Different FMCW-based patterns may be designed to indicate different sync rasters. For example, two or three different patterns may be used for two or three neighboring sync rasters, for example, that have the same value of N but different values of M.

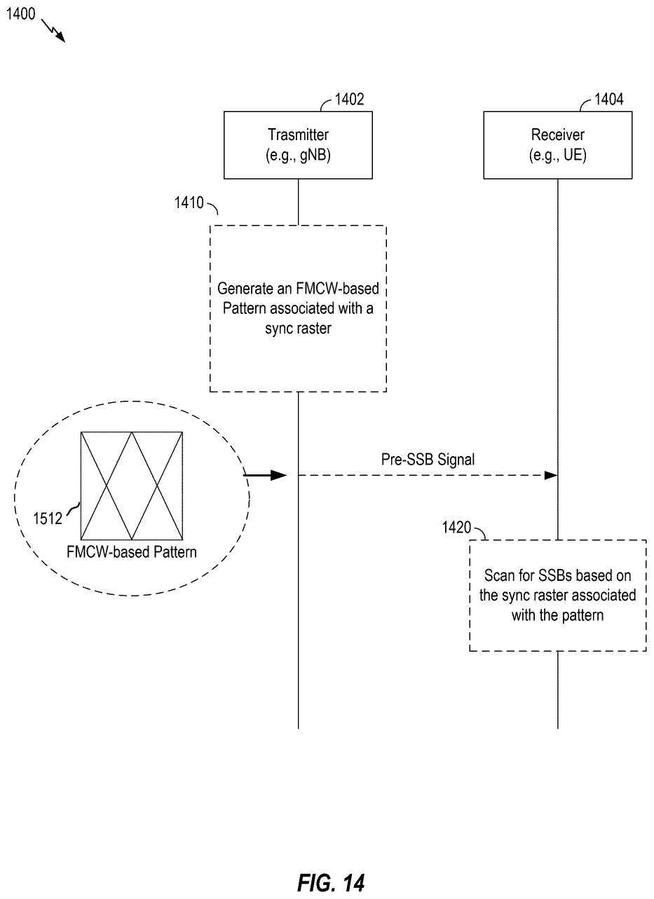

FIG. 14 depicts a call flow diagram 1400, in accordance with aspects of the present disclosure, in which a transmitter (Tx) 1402 transmits an X-shaped FMCW-based synchronization signal to be processed by a receiver (Rx) 1404. In some aspects, the receiver shown in FIG. 14 may be a UE, such as an example of the UE 104 depicted and described with respect to FIGS. 1 and 3. Similarly, the transmitter shown in FIG. 14 may be a network entity, such as an example of the BS 102 (e.g., a gNB) depicted and described with respect to FIGS. 1 and 3 or a disaggregated base station depicted and described with respect to FIG. 2.

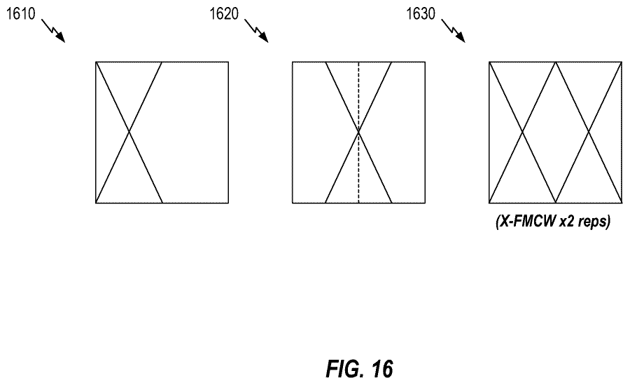

As illustrated at 1410, the transmitter may generate an FMCW-based pattern associated with a certain sync raster (that will be used for SSB deployment). One example pattern 1510 that is illustrated is formed by two repetitions of an X-FMCW signal (in-line with the example pattern 1630 shown in FIG. 16).

As illustrated, the pattern may be transmitted and used as a pre-SSB signal to indicate SSB deployment using the particular raster associated with the pattern. As illustrated at 1420, the UE may detect the pre-SSB signal and scan for SSBs based on the sync raster associated with the pattern.

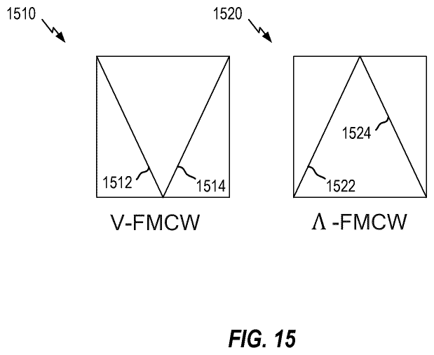

As an alternative (or in addition) to X-FMCW based patterns, other types of FMCW based patterns may also be designed, such as patterns based on V-shaped and inverted V (Λ-FMCW) shaped signals. As illustrated in FIG. 15, a V-shaped FMCW-based pattern 1510 may be formed by an initial down-swept signal 1512, followed by an up-swept signal 1514. Similarly, an inverted V shaped FMCW (Λ-FMCW) based pattern 1520 may be formed by an initial up-swept signal 1522, followed by a down-swept signal 1524.

Different variations of X-FMCW based patterns may also be designed. As illustrated in FIG. 16, the crossing point of an X-shaped FMCW-based pattern 1610 need not occur at the midpoint of a time duration, such as a symbol (as in the example pattern 1620). Further, a more complex pattern 1630 may be formed with (two or more) repetitions of X-shaped patterns with a same time duration.

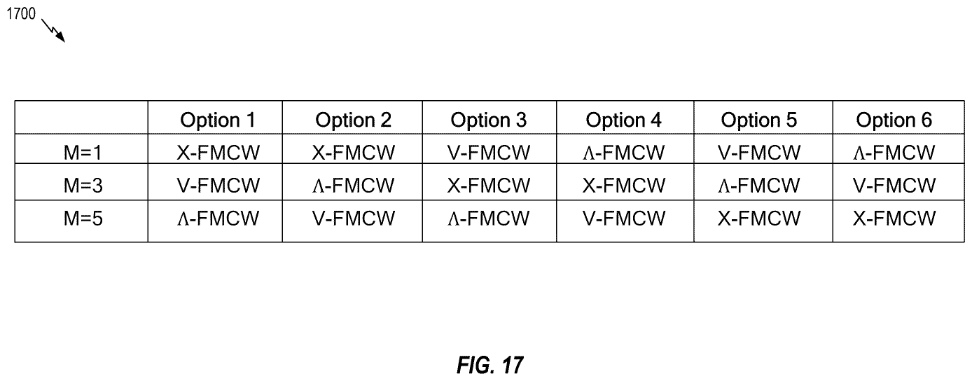

Table 1700 of FIG. 17 illustrates example options for how different patterns may map to different sync rasters. Each option shows how, for sync rasters with different values of M (Mϵ {1,3,5}), the light SSB/pre-SSB could be mapped to (associated with) a different type of X-FMCW, V-FMCW and Λ-FMCW based pattern.

According to a first option, an X-FMCW based pattern (e.g., one of the patterns shown in FIG. 16) may map to a sync raster with a value M=1, a V-FMCW based pattern (e.g., pattern 1510 of FIG. 15) may map to a sync raster with a value M=3, while an inverted V-FMCW (Λ-FMCW) based pattern (e.g., pattern 1520 of FIG. 15) may map to a sync raster with a value M=5. The other options (options 2-6) use different combinations of patterns to map to different sync rasters with different values of M.

In some cases, a particular mapping of patterns to sync patterns may be defined in a standard specification.

Different variations and/or combinations of the same or different types of (X, V, or Λ) patterns may be used to indicate different sync rasters. Additionally, for any of the pattern variations described herein, to reduce UE detection complexity, the slope of the up-swept portion and down-swept portion of the FMCW-based patterns (whether X, V, or Λ) for different values of Mϵ {1,3,5} could be designed to be the same. In other words, the slope of the down-swept portion may be the negative of the slope of the up-swept portion.

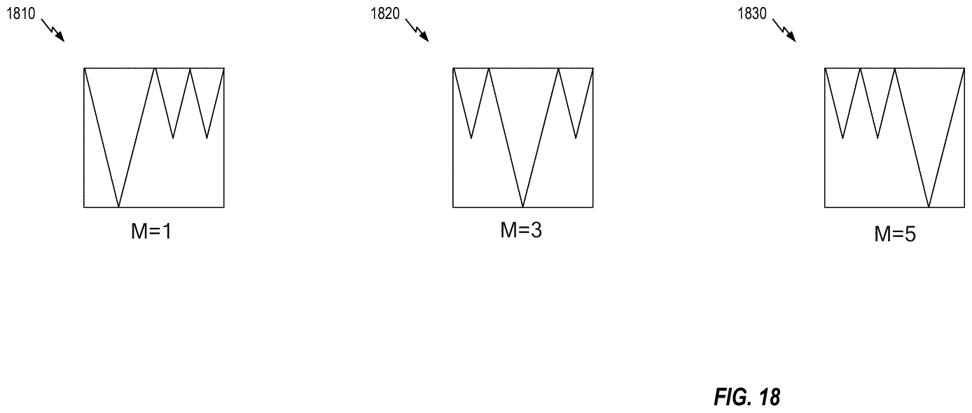

FIG. 18 illustrates examples of patterns formed by a sequence of three V-FMCW signals. Each pattern has one V-FMCW signal with a longer time duration than the others. The location of this longer duration V-FMCW signal may distinguish each pattern and, thus, indicate an associated sync raster.

As indicated, in pattern 1810, this longer duration V-FMCW signal occurs first, indicating a sync raster with M=1. In pattern 1820, this longer duration V-FMCW signal occurs second, indicating a sync raster with M=3. In pattern 1320, this longer duration V-FMCW signal occurs second, indicating a sync raster with M=5.

While the example patterns in FIG. 18, the approach of using a sequence of signals, with different time durations, could be extended to use sequences of X-FMCW and/or Λ-FMCW based patterns.

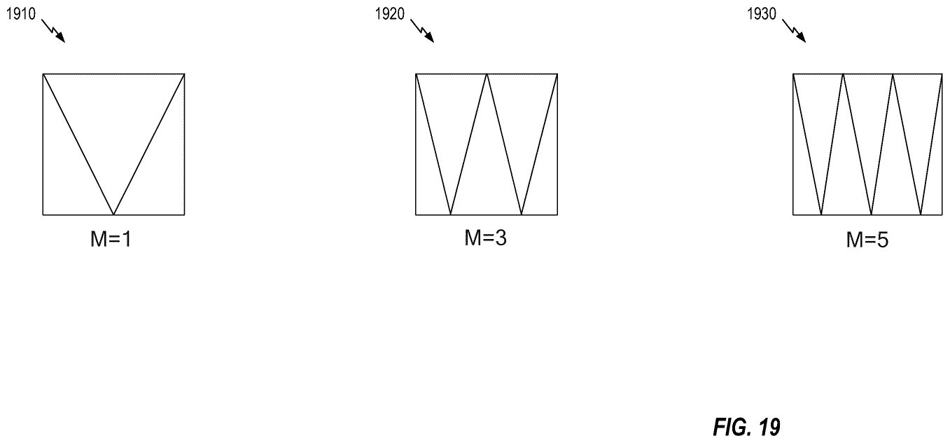

As illustrated in FIG. 19, another way to indicate sync rasters for different values of M is to use a different number of repetitions within a time duration (e.g., a symbol). Different numbers of repetitions M₁,M₃ and M₅ may be used to indicate M=1, M=3, and M=5, respectively (where M₁≠M₃≠M₅). In the illustrated example patterns 1910, 1920, and 1930, M₁=1, M₃=2, and M₅=3.

While repetitions of a V-FMCW signal are shown in the examples illustrated in FIG. 19, the FMCW signals could be either X-FMCW, V-FMCW (as shown) or A-FMCW (or any combination) could be used.

Aspects of the present disclosure also propose various designs that may help address coexistence between light SSB/pre-SSB signals in terrestrial networks (TN) and NTN scenarios under 3 GHz.

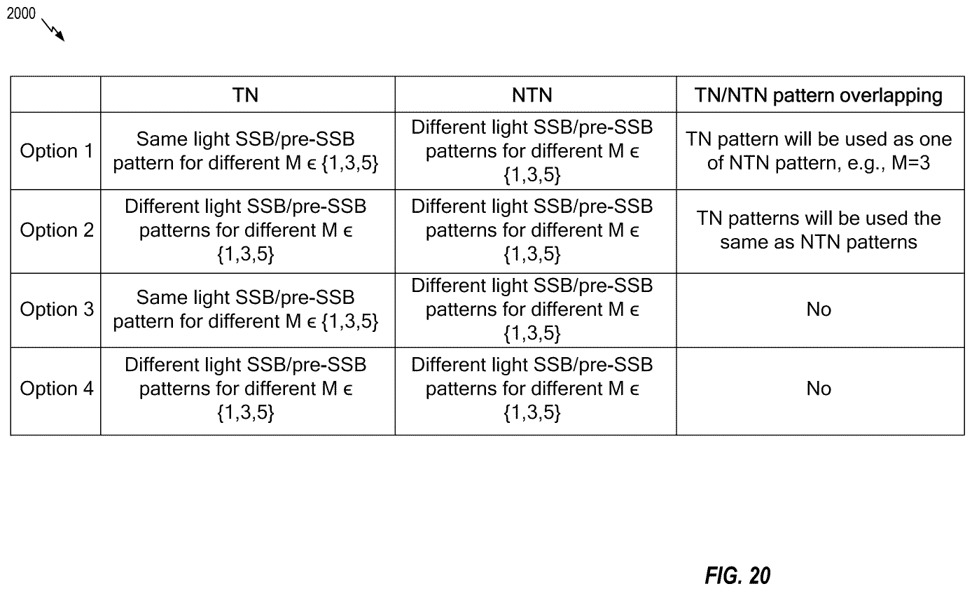

As illustrated in table 2000 of FIG. 20, aspects of the present disclosure provide various options for using different patterns for indicating sync rasters for TN and NTN scenarios.

According to a first option, the same light SSB/pre-SSB pattern are used for different values of M for TNs, while different light SSB/pre-SSB patterns are used for different values of M for NTNs. According to this option, the pattern used for TN may also be used as one of the NTN pattern (e.g., the pattern used for all values of M for TN may be used to indicate M=3 for NTN).

According to a second option, different patterns may be used for different values of M for both TNs and NTNS. According to this option, the same patterns used for TN may also be used for NTN.

According to certain options, there may be no overlapping patterns used for both TN and NTN. For example, according to a third option, TN may use a same pattern for all values of M, but different patterns may be used for the different values of M for NTN scenarios. According to a forth option, different patterns may be used for different values of M for both TNs and NTNS. According to this option, however, different patterns used for TN and NTN (e.g., no overlapping patterns may be used in this option).

As noted above, for some deployments, for 3 GHz, the maximum service link Doppler frequency may be f_{D}=±75 KHz at ±25 ppm. In some cases, certain optimization may be utilized to further reduce UE detection complexity. For example, patterns for M=1 and M=5 (e.g., non-adjacent sync rasters) may be the same (identical) to further reduce the UE detection complexity.

### Example Operations

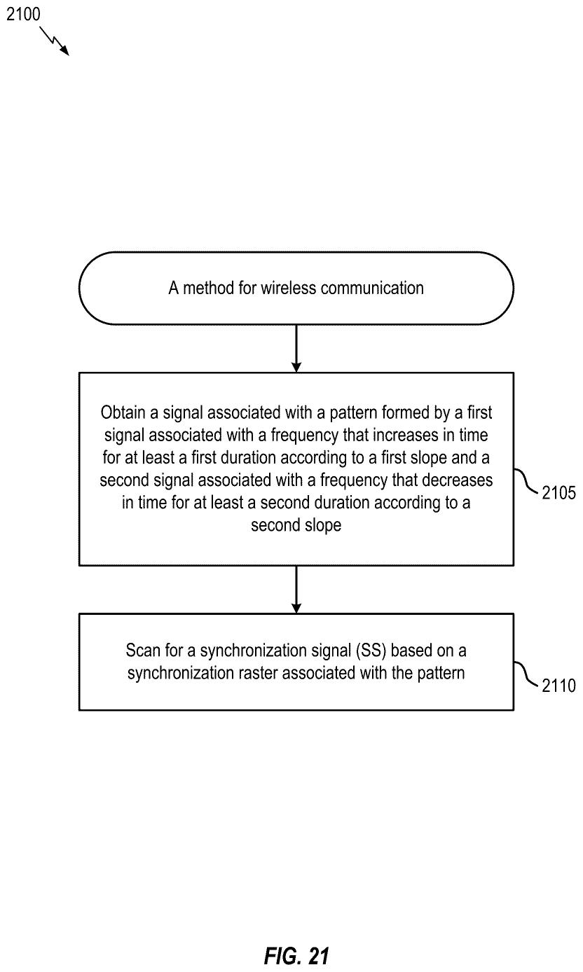

FIG. 21 shows an example of a method 2100 of wireless communication at a wireless node, such as a UE 104 of FIGS. 1 and 3.

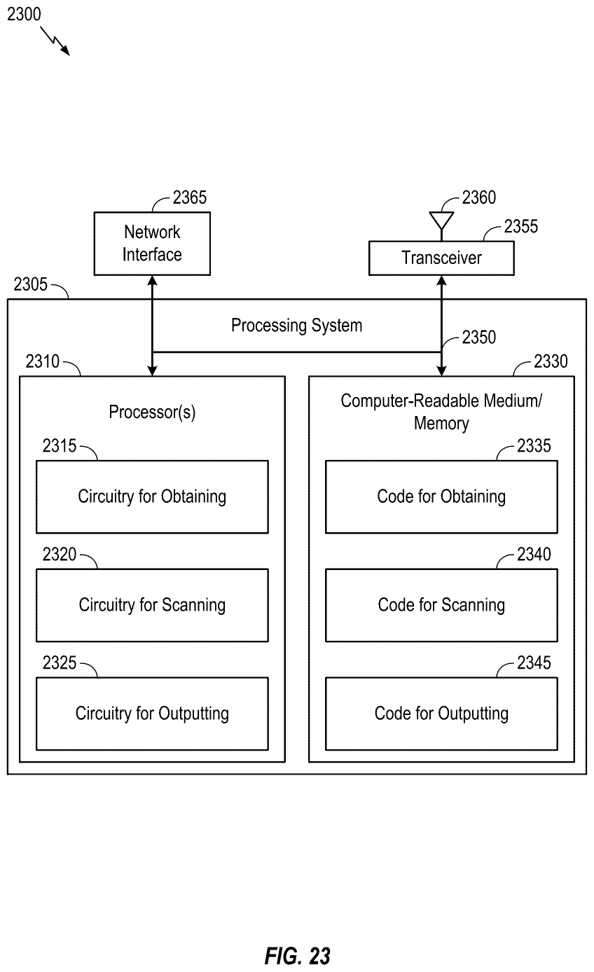

Method 2100 begins at step 2105 with obtaining a signal associated with a pattern formed by a first signal associated with a frequency that increases in time for at least a first duration according to a first slope and a second signal associated with a frequency that decreases in time for at least a second duration according to a second slope. In some cases, the operations of this step refer to, or may be performed by, circuitry for obtaining and/or code for obtaining as described with reference to FIG. 23.

Method 2100 then proceeds to step 2110 with scanning for a synchronization signal (SS) based on a synchronization raster associated with the pattern. In some cases, the operations of this step refer to, or may be performed by, circuitry for scanning and/or code for scanning as described with reference to FIG. 23.

In some aspects, at least one of the first signal or the second signal comprises a frequency modulated continuous waveform (FMCW) signal.

In some aspects, the pattern is one of a plurality of different patterns; and at least some of the different patterns are associated with different synchronization rasters.

In some aspects, each of the different patterns is associated with a value of a parameter, the value being indicative of frequency locations for its associated synchronization raster.

In some aspects, at least two of the different patterns are associated with a same value of the parameter.

In some aspects, the second slope is a negative of the first slope; and the different patterns include at least two of: a first pattern where the second duration occurs before the first duration; a second pattern where the first duration occurs before the second duration; or a third pattern where the first duration and second duration overlap.

In some aspects, at least one of: the first slope is the same for at least two of the different patterns; or the second slope is the same for at least two of the different patterns.

In some aspects, the second slope is a negative of the first slope; each of the different patterns includes at least first and second sub-patterns, each sub-pattern being formed by the first signal and the second signal; and time durations associated with the first sub-pattern and the second sub-pattern are different.

In some aspects, the second slope is a negative of the first slope; and the different patterns include at least: a first pattern formed by a first quantity of one or more repetitions of each of the first signal and the signal and a second pattern formed by a second quantity of repetitions of each of the first signal and the second signal.

In some aspects, at least two patterns of the different patterns are associated with different synchronization rasters associated with a non-terrestrial network (NTN).

In some aspects, at least one pattern of the different patterns is associated with at least one synchronization raster for a terrestrial network (TN).

In some aspects, the at least one pattern is also associated with at least one synchronization raster associated with the NTN.

In some aspects, the at least one pattern comprises a pattern that is associated with multiple synchronization rasters associated with the TN.

In some aspects, the at least two patterns are from a first subset of the different patterns; the at least one pattern is from a second subset of the different patterns; and the first subset and second subset are non-overlapping.

In one aspect, method 2100, or any aspect related to it, may be performed by an apparatus, such as communications device 2300 of FIG. 23, which includes various components operable, configured, or adapted to perform the method 2100. Communications device 2300 is described below in further detail.

Note that FIG. 21 is just one example of a method, and other methods including fewer, additional, or alternative steps are possible consistent with this disclosure.

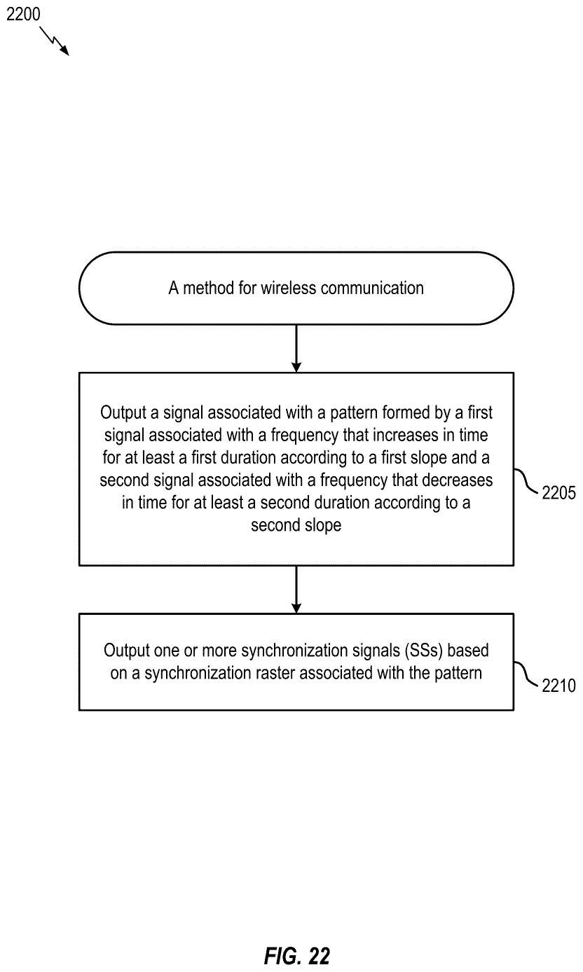

FIG. 22 shows an example of a method 2200 of wireless communication at a wireless node, such as a BS 102 of FIGS. 1 and 3, or a disaggregated base station as discussed with respect to FIG. 2.

Method 2200 begins at step 2205 with outputting a signal associated with a pattern formed by a first signal associated with a frequency that increases in time for at least a first duration according to a first slope and a second signal associated with a frequency that decreases in time for at least a second duration according to a second slope. In some cases, the operations of this step refer to, or may be performed by, circuitry for outputting and/or code for outputting as described with reference to FIG. 23.

Method 2200 then proceeds to step 2210 with outputting one or more synchronization signals (SSs) based on a synchronization raster associated with the pattern. In some cases, the operations of this step refer to, or may be performed by, circuitry for outputting and/or code for outputting as described with reference to FIG. 23.

In some aspects, at least one of the first signal or the second signal comprises a frequency modulated continuous waveform (FMCW) signal.

In some aspects, the pattern is one of a plurality of different patterns; and at least some of the different patterns are associated with different synchronization rasters.

In some aspects, each of the different patterns is associated with a value of a parameter, the value being indicative of frequency locations for its associated synchronization raster.

In some aspects, at least two of the different patterns are associated with a same value of the parameter.

In some aspects, the second slope is a negative of the first slope; and the different patterns include at least two of: a first pattern where the second duration occurs before the first duration; a second pattern where the first duration occurs before the second duration; or a third pattern where the first duration and second duration overlap.

In some aspects, at least one of: the first slope is the same for at least two of the different patterns; or the second slope is the same for at least two of the different patterns.

In some aspects, the second slope is a negative of the first slope; each of the different patterns includes at least first and second sub-patterns, each sub-pattern being formed by the first signal and the second signal; and time durations associated with the first sub-pattern and the second sub-pattern are different.

In some aspects, the second slope is a negative of the first slope; and the different patterns include at least: a first pattern formed by a first quantity of one or more repetitions of each of the first signal and the signal and a second pattern formed by a second quantity of repetitions of each of the first signal and the second signal.

In some aspects, at least two patterns of the different patterns are associated with different synchronization rasters associated with a non-terrestrial network (NTN).

In some aspects, at least one pattern of the different patterns is associated with at least one synchronization raster for a terrestrial network (TN).

In some aspects, the at least one pattern is also associated with at least one synchronization raster associated with the NTN.

In some aspects, the at least one pattern comprises a pattern that is associated with multiple synchronization rasters associated with the TN.

In some aspects, the at least two patterns are from a first subset of the different patterns; the at least one pattern is from a second subset of the different patterns; and the first subset and second subset are non-overlapping.

In one aspect, method 2200, or any aspect related to it, may be performed by an apparatus, such as communications device 2300 of FIG. 23, which includes various components operable, configured, or adapted to perform the method 2200. Communications device 2300 is described below in further detail.

Note that FIG. 22 is just one example of a method, and other methods including fewer, additional, or alternative steps are possible consistent with this disclosure.

### Example Communications Device(s)

FIG. 23 depicts aspects of an example communications device 2300. In some aspects, communications device 2300 is a user equipment, such as UE 104 described above with respect to FIGS. 1 and 3. In some aspects, communications device 2300 is a network entity, such as BS 102 of FIGS. 1 and 3, or a disaggregated base station as discussed with respect to FIG. 2.

The communications device 2300 includes a processing system 2305 coupled to the transceiver 2355 (e.g., a transmitter and/or a receiver). In some aspects (e.g., when communications device 2300 is a network entity), processing system 2305 may be coupled to a network interface 2365 that is configured to obtain and send signals for the communications device 2300 via communication link(s), such as a backhaul link, midhaul link, and/or fronthaul link as described herein, such as with respect to FIG. 2. The transceiver 2355 is configured to transmit and receive signals for the communications device 2300 via the antenna 2360, such as the various signals as described herein. The processing system 2305 may be configured to perform processing functions for the communications device 2300, including processing signals received and/or to be transmitted by the communications device 2300.

The processing system 2305 includes one or more processors 2310. In various aspects, the one or more processors 2310 may be representative of one or more of receive processor 358, transmit processor 364, TX MIMO processor 366, and/or controller/processor 380, as described with respect to FIG. 3. In various aspects, one or more processors 2310 may be representative of one or more of receive processor 338, transmit processor 320, TX MIMO processor 330, and/or controller/processor 340, as described with respect to FIG. 3. The one or more processors 2310 are coupled to a computer-readable medium/memory 2330 via a bus 2350. In certain aspects, the computer-readable medium/memory 2330 is configured to store instructions (e.g., computer-executable code) that when executed by the one or more processors 2310, cause the one or more processors 2310 to perform the method 2100 described with respect to FIG. 21, or any aspect related to it; and the method 2200 described with respect to FIG. 22, or any aspect related to it. Note that reference to a processor performing a function of communications device 2300 may include one or more processors 2310 performing that function of communications device 2300.

In the depicted example, computer-readable medium/memory 2330 stores code (e.g., executable instructions), such as code for obtaining 2335, code for scanning 2340, and code for outputting 2345. Processing of the code for obtaining 2335, code for scanning 2340, and code for outputting 2345 may cause the communications device 2300 to perform the method 2100 described with respect to FIG. 21, or any aspect related to it; and the method 2200 described with respect to FIG. 22, or any aspect related to it.

The one or more processors 2310 include circuitry configured to implement (e.g., execute) the code stored in the computer-readable medium/memory 2330, including circuitry for obtaining 2315, circuitry for scanning 2320, and circuitry for outputting 2325. Processing with circuitry for obtaining 2315, circuitry for scanning 2320, and circuitry for outputting 2325 may cause the communications device 2300 to perform the method 2100 described with respect to FIG. 21, or any aspect related to it; and the method 2200 described with respect to FIG. 22, or any aspect related to it.

Various components of the communications device 2300 may provide means for performing the method 2100 described with respect to FIG. 21, or any aspect related to it; and the method 2200 described with respect to FIG. 22, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2355 and the antenna 2360 of the communications device 2300 in FIG. 23. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2355 and the antenna 2360 of the communications device 2300 in FIG. 23.

### Example Clauses

Implementation examples are described in the following numbered clauses:
Clause 1: A method for wireless communication, comprising: obtaining a signal associated with a pattern formed by a first signal associated with a frequency that increases in time for at least a first duration according to a first slope and a second signal associated with a frequency that decreases in time for at least a second duration according to a second slope; and scanning for a synchronization signal (SS) based on a synchronization raster associated with the pattern.
Clause 2: The method of Clause 1, wherein at least one of the first signal or the second signal comprises a frequency modulated continuous waveform (FMCW) signal.
Clause 3: The method of any one of Clauses 1-2, wherein: the pattern is one of a plurality of different patterns; and at least some of the different patterns are associated with different synchronization rasters.
Clause 4: The method of Clause 3, wherein: each of the different patterns is associated with a value of a parameter, the value being indicative of frequency locations for its associated synchronization raster.
Clause 5: The method of Clause 4, wherein: at least two of the different patterns are associated with a same value of the parameter.
Clause 6: The method of Clause 3, wherein: the second slope is a negative of the first slope; and the different patterns include at least two of: a first pattern where the second duration occurs before the first duration; a second pattern where the first duration occurs before the second duration; or a third pattern where the first duration and second duration overlap.
Clause 7: The method of Clause 3, wherein at least one of: the first slope is the same for at least two of the different patterns; or the second slope is the same for at least two of the different patterns.
Clause 8: The method of Clause 3, wherein: the second slope is a negative of the first slope; each of the different patterns includes at least first and second sub-patterns, each sub-pattern being formed by the first signal and the second signal; and time durations associated with the first sub-pattern and the second sub-pattern are different.
Clause 9: The method of Clause 3, wherein: the second slope is a negative of the first slope; and the different patterns include at least: a first pattern formed by a first quantity of one or more repetitions of each of the first signal and the signal and a second pattern formed by a second quantity of repetitions of each of the first signal and the second signal.
Clause 10: The method of Clause 3, wherein: at least two patterns of the different patterns are associated with different synchronization rasters associated with a non-terrestrial network (NTN).
Clause 11: The method of Clause 10, wherein at least one pattern of the different patterns is associated with at least one synchronization raster for a terrestrial network (TN).
Clause 12: The method of Clause 11, wherein the at least one pattern is also associated with at least one synchronization raster associated with the NTN.
Clause 13: The method of Clause 11, wherein the at least one pattern comprises a pattern that is associated with multiple synchronization rasters associated with the TN.
Clause 14: The method of Clause 11, wherein: the at least two patterns are from a first subset of the different patterns; the at least one pattern is from a second subset of the different patterns; and the first subset and second subset are non-overlapping.
Clause 15: A method for wireless communication, comprising: outputting a signal associated with a pattern formed by a first signal associated with a frequency that increases in time for at least a first duration according to a first slope and a second signal associated with a frequency that decreases in time for at least a second duration according to a second slope; and outputting one or more synchronization signals (SSs) based on a synchronization raster associated with the pattern.
Clause 16: The method of Clause 15, wherein at least one of the first signal or the second signal comprises a frequency modulated continuous waveform (FMCW) signal.
Clause 17: The method of any one of Clauses 15-16, wherein: the pattern is one of a plurality of different patterns; and at least some of the different patterns are associated with different synchronization rasters.
Clause 18: The method of Clause 17, wherein: each of the different patterns is associated with a value of a parameter, the value being indicative of frequency locations for its associated synchronization raster.
Clause 19: The method of Clause 18, wherein: at least two of the different patterns are associated with a same value of the parameter.
Clause 20: The method of Clause 17, wherein: the second slope is a negative of the first slope; and the different patterns include at least two of: a first pattern where the second duration occurs before the first duration; a second pattern where the first duration occurs before the second duration; or a third pattern where the first duration and second duration overlap.
Clause 21: The method of Clause 17, wherein at least one of: the first slope is the same for at least two of the different patterns; or the second slope is the same for at least two of the different patterns.
Clause 22: The method of Clause 17, wherein: the second slope is a negative of the first slope; each of the different patterns includes at least first and second sub-patterns, each sub-pattern being formed by the first signal and the second signal; and time durations associated with the first sub-pattern and the second sub-pattern are different.
Clause 23: The method of Clause 17, wherein: the second slope is a negative of the first slope; and the different patterns include at least: a first pattern formed by a first quantity of one or more repetitions of each of the first signal and the signal and a second pattern formed by a second quantity of repetitions of each of the first signal and the second signal.
Clause 24: The method of Clause 17, wherein: at least two patterns of the different patterns are associated with different synchronization rasters associated with a non-terrestrial network (NTN).
Clause 25: The method of Clause 24, wherein at least one pattern of the different patterns is associated with at least one synchronization raster for a terrestrial network (TN).
Clause 26: The method of Clause 25, wherein the at least one pattern is also associated with at least one synchronization raster associated with the NTN.
Clause 27: The method of Clause 25, wherein the at least one pattern comprises a pattern that is associated with multiple synchronization rasters associated with the TN.
Clause 28: The method of Clause 25, wherein: the at least two patterns are from a first subset of the different patterns; the at least one pattern is from a second subset of the different patterns; and the first subset and second subset are non-overlapping.
Clause 29: An apparatus, comprising: at least one memory comprising executable instructions; and at least one processor configured to execute the executable instructions and cause the apparatus to perform a method in accordance with any combination of Clauses 1-28.
Clause 30: An apparatus, comprising means for performing a method in accordance with any combination of Clauses 1-28.
Clause 31: A non-transitory computer-readable medium comprising executable instructions that, when executed by at least one processor of an apparatus, cause the apparatus to perform a method in accordance with any combination of Clauses 1-28.
Clause 32: A computer program product embodied on a computer-readable storage medium comprising code for performing a method in accordance with any combination of Clauses 1-28.
Clause 33: A wireless node (e.g., a UE), including: at least one transceiver; at least one memory including executable instructions; and at least one processor configured to execute the executable instructions and cause the wireless node to perform a method in accordance with any combination of Clauses 1-14, wherein the at least one transceiver is configured to receive the signal.
Clause 34: A wireless node (e.g., a network entity), including: at least one transceiver; at least one memory including executable instructions; and at least one processor configured to execute the executable instructions and cause the wireless node to perform a method in accordance with any combination of Clauses 15-29, wherein the at least one transceiver is configured to transmit the signal and the one or more SSs.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for obtaining, means for scanning, and means for outputting may comprise one or more processors, such as one or more of the processors described above with reference to FIG. 23.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions to cause the apparatus to:
obtain a signal associated with a pattern formed by a first signal associated with a frequency that increases in time for at least a first duration according to a first slope and a second signal associated with a frequency that decreases in time for at least a second duration according to a second slope; and
scan for a synchronization signal (SS) based on a synchronization raster associated with the pattern.

2. The apparatus of claim 1, wherein at least one of the first signal or the second signal comprises a frequency modulated continuous waveform (FMCW) signal.

3. The apparatus of claim 1, wherein:
the pattern is one of a plurality of different patterns; and
at least some of the different patterns are associated with different synchronization rasters.

4. The apparatus of claim 3, wherein:
each of the different patterns is associated with a value of a parameter, the value being indicative of frequency locations for its associated synchronization raster.

5. The apparatus of claim 4, wherein:
at least two of the different patterns are associated with a same value of the parameter.

6. The apparatus of claim 3, wherein:
the second slope is a negative of the first slope; and
the different patterns include at least two of:
a first pattern where the second duration occurs before the first duration;
a second pattern where the first duration occurs before the second duration; or
a third pattern where the first duration and second duration overlap.

7. The apparatus of claim 3, wherein at least one of:
the first slope is the same for at least two of the different patterns; or
the second slope is the same for at least two of the different patterns.

8. The apparatus of claim 3, wherein:
the second slope is a negative of the first slope;
each of the different patterns includes at least first and second sub-patterns, each sub-pattern being formed by the first signal and the second signal; and
time durations associated with the first sub-pattern and the second sub-pattern are different.

9. The apparatus of claim 3, wherein:
the second slope is a negative of the first slope; and
the different patterns include at least:
a first pattern formed by a first quantity of one or more repetitions of each of the first signal and the signal and a second pattern formed by a second quantity of repetitions of each of the first signal and the second signal.

10. The apparatus of claim 3, wherein:
at least two patterns of the different patterns are associated with different synchronization rasters associated with a non-terrestrial network (NTN).

11. The apparatus of claim 10, wherein
at least one pattern of the different patterns is associated with at least one synchronization raster for a terrestrial network (TN).

12. The apparatus of claim 11, wherein the at least one pattern is also associated with at least one synchronization raster associated with the NTN.

13. The apparatus of claim 11, wherein the at least one pattern comprises a pattern that is associated with multiple synchronization rasters associated with the TN.

14. The apparatus of claim 11, wherein:
the at least two patterns are from a first subset of the different patterns;
the at least one pattern is from a second subset of the different patterns; and
the first subset and second subset are non-overlapping.

15. The apparatus of claim 1, further comprising at least one transceiver configured to receive the signal, wherein the apparatus is configured as a user equipment (UE).

16. An apparatus for wireless communication, comprising:
at least one memory comprising computer-executable instructions; and
one or more processors configured to execute the computer-executable instructions to cause the apparatus to:
output a signal associated with a pattern formed by a first signal associated with a frequency that increases in time for at least a first duration according to a first slope and a second signal associated with a frequency that decreases in time for at least a second duration according to a second slope; and
output one or more synchronization signals (SSs) based on a synchronization raster associated with the pattern.

17. The apparatus of claim 16, wherein at least one of the first signal or the second signal comprises a frequency modulated continuous waveform (FMCW) signal.

18. The apparatus of claim 16, wherein:
the pattern is one of a plurality of different patterns; and
at least some of the different patterns are associated with different synchronization rasters.

19. The apparatus of claim 16, further comprising at least one transceiver configured to transmit at least one of the signal or the one or more SSs, wherein the apparatus is configured as a network entity.

20. A method for wireless communication at a wireless node, comprising:
obtaining a signal associated with a pattern formed by a first signal associated with a frequency that increases in time for at least a first duration according to a first slope and a second signal associated with a frequency that decreases in time for at least a second duration according to a second slope; and
scanning for a synchronization signal (SS) based on a synchronization raster associated with the pattern.
